(19) United States
(12) Patent Application Publication
(10) Pub. No.: US 2010/0082667 A1
(43) Pub. Date: Apr. 1, 2010

(54) UTILIZING A SOCIAL NETWORK FOR LOCATING A TARGET INDIVIDUAL BASED UPON A PROXIMITY SEARCH

(75) Inventors: Sean Callanan, Dublin (IE); Patrick J. O' Sullivan, Ballsbridge (IE); Hema Srikanth, Raleigh, NC (US); Carol S. Zimmet, Boxborough, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/234,864

(22) Filed: Sep. 22, 2008

(51) Int. Cl. G06F 17/30

(52) U.S. Cl. 707/770; 707/E17.018

(57) ABSTRACT

A method of utilizing a social network for locating a target individual based upon a proximity search can be provided. In one embodiment of the invention, a method of utilizing a social network for locating a target individual based upon proximity search can include identifying a geographic location for a mobile computing device of a target individual, retrieving a list of contacts from a social network associated with the target individual, generating a subset of the contacts according to a proximity of available ones of the contacts to the identified geographic location for the mobile computing device, and prompting at least one of the contacts in the subset to alert the target individual.

### BACKGROUND OF THE INVENTION

The present invention broadly relates to the field of presence awareness in a messaging system and more particularly to the field of user location for messaging in a messaging system.

Instant messaging (IM) and short message service (SMS) messaging represent the prevalent way of communicating and collaborating amongst peers. Often the challenge exists when a person is not available to communicate online, or via phone, cell, SMS, pager, etc. Yet, the situation often arises when a person must be contacted immediately—e.g. for a work crisis or an urgent family matter. More typically, one can expect a person to attend an online or in-person meeting, but the person can fail to attend the online or in-person meeting. In either circumstance, IM and SMS messaging provide an effective way of quickly communicating with the absent person to notify the person of their unexpected absence or the necessity for their presence. When the person does not respond to IM or SMS messaging; however, the opportunity to cure the absence is lost.

### BRIEF SUMMARY OF THE INVENTION

Embodiments of the invention provide for a method of utilizing a social network for locating a target individual based upon a proximity search. The method can include identifying a geographic location for a mobile computing device, for example a cellular telephone, of a target individual. The method further can include retrieving a list of contacts from a social network associated with the target individual. The method yet further can include generating a subset of contacts from the retrieved list according to the proximity of available ones of the contacts to the identified geographic location for the mobile computing device. Finally, the method can include prompting at least one of the contacts in the retrieved subset to alert the target individual.

Another embodiment of the invention provides for a method for identifying a geographic location for a mobile computing device of a querying user. The method can include selecting at least one proximity search parameter for filtering contacts in a social network associated with the querying user. The proximity search parameter can relate to the proximity of available ones of the contacts in the social network to a geographic location for a mobile computing device of the querying user. As such, the method also can include retrieving a list of contacts from the social network according to the proximity search parameter. Thereafter, at least one of the contacts in the list can be prompted to communicate with the querying user responsive to having at least one common user-defined preference, for example a common hobby between the querying user and the available contact.

Yet another embodiment of the invention can provide for a proximity search data processing system configured to utilize a social network for locating a target individual. The system can include a memory, a processor, a bus connecting the processor, and the memory, and proximity search logic coupled to the memory. The search logic can include program code enabled to identify a geographic location for a mobile computing device of a target individual. The program code further can be enabled to retrieve a list of contacts from a social network associated with the target individual and to generate a subset of the contacts in the retrieved list according to the proximity of available ones of the contacts in the subset to the identified geographic location. Finally, the program code can be enabled to prompt at least one of the contacts in the subset to alert the target individual of a desire to locate the target individual.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention.

FIG. 1 is a pictorial illustration of a process for utilizing a social network for locating a target individual based upon a proximity search;

FIG. 2 is a schematic illustration of a proximity search data processing system configured for utilizing a social network for locating a target individual based upon a proximity search; and

FIG. 3 is a flowchart illustration of a process for utilizing a social network for locating a target individual based upon a proximity search.

### DETAILED DESCRIPTION OF THE INVENTION

As will be appreciated by one skilled in the art, the present invention may be embodied as a method, data processing system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Exemplary embodiments of the invention provide techniques for utilizing a social network to locate a target individual based upon a proximity search of the social network. Specifically, in accordance with an embodiment of the invention, a querying user can identify a geographic location for a mobile computing device of the target individual. The current or last known location of the target individual can be determined by GPS or cellular triangulation data for the mobile computing device. Once the location of the target individual has been determined, a social network of the target individual can be queried with respect to the location. A resulting selection of contacts within geographic proximity of the last known location can be presented in order to allow the querying user to prompt the contacts in the selection for assistance in alerting the target individual of a desire to locate the target individual.

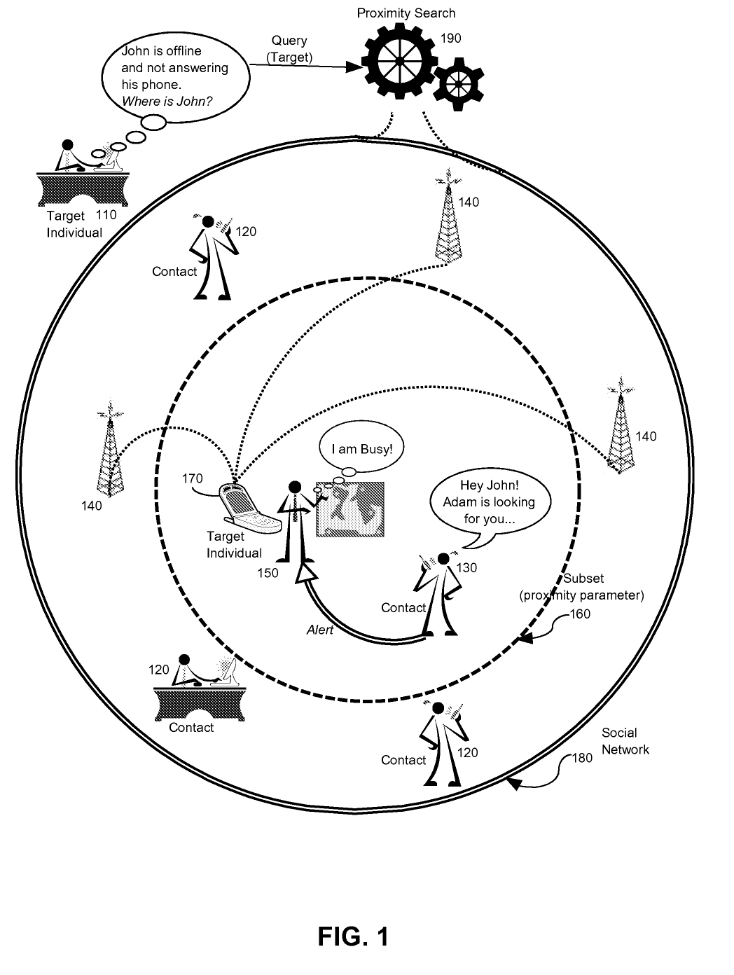

In illustration, FIG. 1 pictorially depicts a process for utilizing a social network for locating a target individual based upon a proximity search. As shown in FIG. 1, a querying user 110 via network client can initiate a search request of a target individual 150 that cannot be contacted through telephone or messaging. In order to locate the target individual 150, contacts 120, 130 within a social network 280 of the target individual can be enlisted to alert the target individual 150 of the desire by the querying user 110 to locate the target individual 150.

Specifically, the querying user 110 can query proximity search system 190 to retrieve the current or last known location of a mobile computing device 170 of the target individual 150. For instance, the location for the mobile computing device 170 of the target individual 150 can be determined through cellular triangulation 140 of the mobile computing device 170, or through GPS data provided by the mobile computing device 170. Each location of a communicatively accessible and available one of the contacts 120, 130 belonging to a social network 180 of the target individual 150 can be compared to a threshold proximity of the target individual 150.

In this regard, each of the contacts 120, 130 can be determined to be “available” by way of presence awareness included in a common messaging system for the contacts 120, 130. Further, the threshold proximity can be defined dynamically according to a search rule specified by the target individual 150. In any case, a resulting subset 160 of contacts 130 deemed to be available and proximately positioned to the target individual 150 can be determined. Thereafter, contacts 130 in the subset 160 can be prompted to alert the target individual 150 of the desire of the querying user 110 to contact the target individual 150. Optionally, after the target individual 150 has been located, the search can be terminated by way of a follow-up broadcast message to the contacts 130 in the subset 160 to convey successful completion of the proximity search.

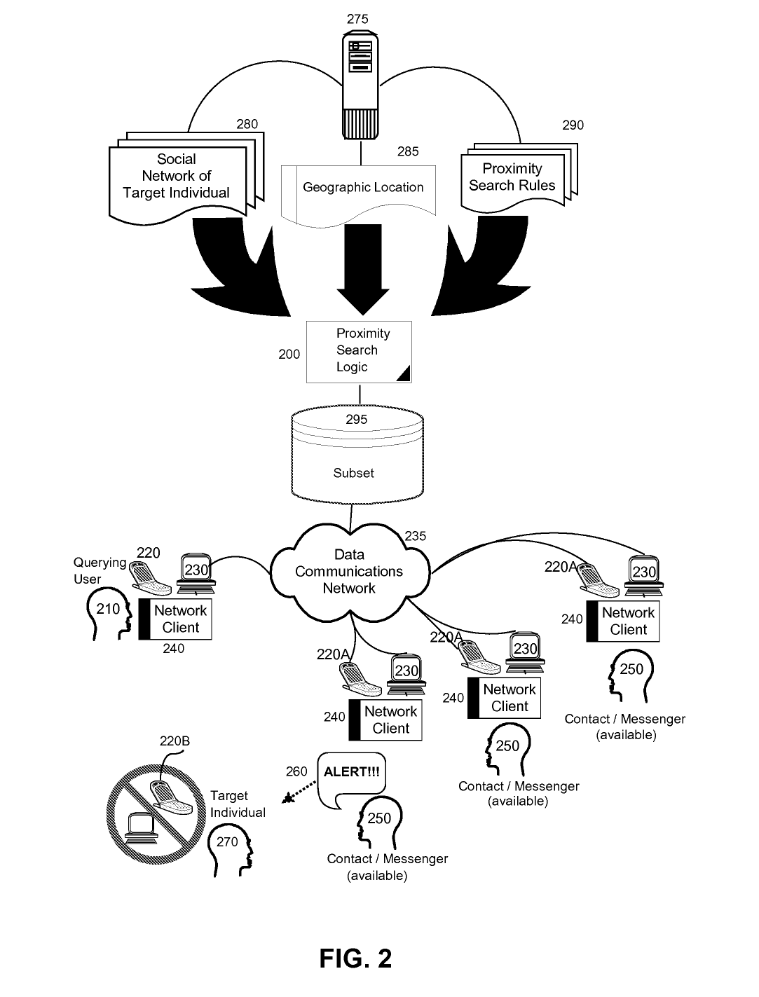

The process described in connection with FIG. 1 can be implemented within a proximity search data processing system. In illustration, FIG. 2 schematically shows a proximity search data processing system configured for utilizing a social network for locating a target individual. The system can include a network server 275 accessing a social network 280 of a target individual 270, a mobile computing device location 285 of the target individual 270, and user-defined proximity parameters (search rules) 290. The system also can include proximity search logic 200 executing in the network server 270.

The proximity search logic 200 can include program code enabled to identify the last known or current geographic location 285 of a mobile computing device 220B of the target individual 270. The program code further can be enabled to retrieve a list of contacts 250 from the social network 280 of the target individual 270. The program code yet further can be enabled to generate a subset 295 of the contacts 250 in the list according to a proximity of available ones of the contacts 250 to the identified geographic location. Finally, the program code can be enabled to prompt at least one of the contacts 250 in the subset to alert the target individual 270 of the desire by a querying user 210.

More particularly, in operation the querying user 210, utilizing a network client 240 in a cell phone 220 or alternatively any other computing device 230, can prompt each of the contacts 250 in the subset 295 over a data communications network 235 to alert the target individual 270. Each of the contacts 250 can receive the prompt through a respective network client 240 in a cell phone 220A, or alternatively within any other computing device 230. Each of the contacts 250 in the subset 295, in turn, can provide an alert to the target individual 270 by way of in person communication, or remote communication. Exemplary forms of the alert can include a verbal or written statement communicated to the target individual 270.

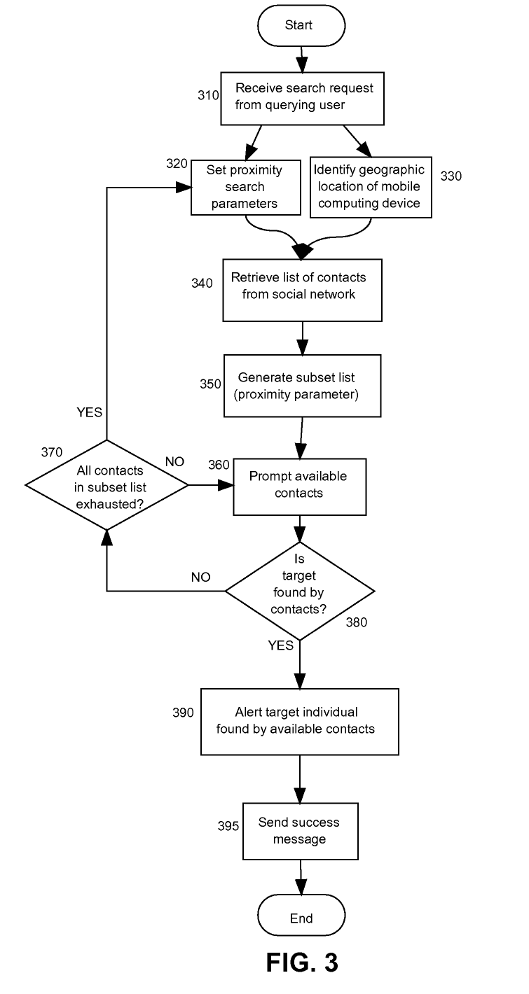

In yet further illustration, FIG. 3 is a flowchart illustration of a process for utilizing a social network for locating a target individual based upon a proximity search. In block 310, a search request can be received from a querying user. Next, in blocks 320 and 330, user-specified proximity search parameters (search rules) can be established, and the geographic location of the mobile computing device can be identified. The location can be determined, for instance, by triangulating the cellular location of the mobile computing device of the target individual or via GPS data provided by the mobile computing device.

By way of example, a user interface can be rendered for the benefit of the querying user with a search option labeled “Show me n-nearest network contacts (directly or indirectly connected) for a target individual X”. Additionally, the user interface can accept the specification of the proximity search parameters for filtering contacts in the social network of the target individual and for determining geographic proximity. An example includes “within 10 feet away and 2^{nd} or 3^{rd} degree social network connections”. Additional search parameters can include dynamic rules such as “refine list to contacts reachable via IM application (online), or cell phone”, or “refine list to contacts who are part of work team, college network, connected directly (or indirectly) via a social network application”, and the like.

In block 340, a list of contacts from the social network of the target individual can be retrieved and in block 350 the list can be filtered according to the proximity search parameters, with static parameters or dynamic rules, to a subset of n-nearest network contacts within a user-defined distance. Subsequently, in block 360 a first contact in the subset can be prompted to alert the target individual. For instance, the contact in the subset can be prompted by way of instant messaging, phone call, SMS or e-mail.

In decision block 380, if the prompted contact cannot communicate with the target individual, it can be determined in decision block 370 whether additional contacts in the subset remain to be prompted. If so, the process can repeat in block 360 for a next contact in the subset. In decision block 370, when all the contacts in the subset have been prompted and if the contacts in the subset have been unable to communicate with the target individual, the process can continue in block 320 with the refinement of the proximity search parameters. Otherwise, in decision block 380 if a contact in the subset successfully communicates with the target individual, in block 390 the contact can alert the target individual.

Of note, though the process of FIG. 3 contemplates the individual prompting of each of the contacts in the subset, in an alternative aspect of the embodiment, the prompt can be provided by way of a broadcast message to the contacts in the subset. As a further option, user-specified content can be included with the prompt to indicate the reason for which the contacts in the subset have being asked to locate the target individual. Even further, the broadcast message can include an indication that other contacts in the subset have been prompted for assistance. To the extent that the querying user and one or more of the contacts in the subset are not connected with close proximity in the social network, the connection between the querying user and the target individual can be indicated within the prompt. In any case, in block 395, a success message can be sent to the contacts of the subset.

Additional optional embodiments include establishing for different contacts an “acquaintance list” of contacts that can be used during a proximity search as a selection of contacts to be prompted in lieu of or in addition to the contacts in the subset. Alternatively, a list of contacts sharing similar interests, such as a common hobby, can be established for prompting during a proximity search. As yet an additional aspect of the embodiments, a preference can be established to permit the identification of a location of a target individual only at the behest of a querying user connected according to a threshold degree of separation between target individual and querying user. For example only first and second degree social network contacts of a target individual can conduct a proximity search for the target individual.

Even yet further, privacy limitations on proximity searching a target individual can be enabled and disabled according to do-not-disturb preferences of the target individual. Finally, a search history can be compiled of individuals most targeted for proximity searching, and by which contacts those target individuals were most often found. Subsequent filtering of the contacts in the social network into the subset can account for those contacts who historically have been successful in locating a target individual of interest.

Having thus described the invention of the present application in detail and by reference to embodiments thereof, it will be apparent that modifications and variations are possible without departing from the scope of the invention defined in the appended claims.

We claim:

1. A method of utilizing a social network for locating a target individual based on a proximity search, the method comprising:
identifying a geographic location for a mobile computing device of a target individual;
retrieving a list of contacts from a social network associated with the target individual;
generating a subset of the contacts in the list according to a proximity of available ones of the contacts to the identified geographic location; and
prompting at least one contact in the subset to alert the target individual.

2. The method of claim 1, further comprising:
receiving a search request to locate the target individual;
extracting from the search request at least one proximity search parameter specifying at least a requisite proximity to the target individual and a degree of connectivity in the social network with the target individual; and,
determining the proximity according to the at least one proximity search parameter when generating the subset.

3. The method of claim 1, further comprising:
retrieving an acquaintance list of the target individual; and,
generating the subset with contacts in the acquaintance list in lieu of contacts in the list generated according to the proximity.

4. The method of claim 1, wherein identifying a geographic location for a mobile computing device of a target individual comprises identifying a geographic location for a mobile computing device through one of cellular triangulation of the mobile computing device and GPS data provided by the mobile computing device.

5. The method of claim 1, further comprising:
compiling a search history of contacts most successful in locating the target individual; and,
generating the subset with contacts indicated by the search history in lieu of contacts in the list generated according to the proximity.

6. The method of claim 1, further comprising performing the identifying, retrieving, generating and prompting only for a querying user connected to the target individual in the social network within a threshold degree of separation.

7. A proximity search data processing system configured for utilizing a social network for locating a target individual comprising:
a memory;
a processor;
a bus connecting the processor, and the memory; and
proximity search logic coupled to the memory, the logic comprising program code enabled (1) to identify a geographic location for a mobile computing device of a target individual, (2) to retrieve a list of contacts from a social network associated with the target individual; (3) to generate a subset of the contacts according to a proximity of available ones of the contacts to the identified geographic location for the mobile computing device, and (4) to prompt at least one of the contacts in the subset list to alert the target individual.

11. A computer program product for utilizing a social network for locating a target individual based upon a proximity search, the computer program product comprising a computer usable medium having computer usable code embodied therewith, the computer usable code comprising:
computer usable program code for identifying a geographic location for a mobile computing device of a target individual;
computer usable program code for retrieving a list of contacts from a social network associated with the target individual;
computer usable program code for generating a subset of the contacts in the list according to a proximity of available ones of the contacts to the identified geographic location; and
computer usable program code for prompting at least one contact in the subset to alert the target individual.

12. The computer program product of claim 11, further comprising:
computer usable program code for receiving a search request to locate the target individual;
computer usable program code for extracting from the search request at least one proximity search parameter specifying at least a requisite proximity to the target individual and a degree of connectivity in the social network with the target individual; and,
computer usable program code for determining the proximity according to the at least one proximity search parameter when generating the subset.

13. The computer program product of claim 11, further comprising:
computer usable program code for retrieving an acquaintance list of the target individual; and,
computer usable program code for generating the subset with contacts in the acquaintance list in lieu of contacts in the list generated according to the proximity.

14. The computer program product of claim 11, wherein the computer usable program code for identifying a geographic location for a mobile computing device of a target individual comprises computer usable program code for identifying a geographic location for a mobile computing device through one of cellular triangulation of the mobile computing device and GPS data provided by the mobile computing device.

15. The computer program product of claim 11, further comprising:
computer usable program code for compiling a search history of contacts most successful in locating the target individual; and,
computer usable program code for generating the subset with contacts indicated by the search history in lieu of contacts in the list generated according to the proximity.

16. The computer program product of claim 1 1, further comprising computer usable program code for performing the identifying, retrieving, generating and prompting only for a querying user connected to the target individual in the social network within a threshold degree of separation.
